(19) United States
(12) Patent Application Publication
(10) Pub. No.: US 2022/0241827 A1
(43) Pub. Date: Aug. 4, 2022

(54) DEBRIS CATCHING DEVICE

(71) Applicant: Walter FRANCIS, Stafford, VA (US)

(72) Inventor: Walter FRANCIS, Stafford, VA (US)

(21) Appl. No.: 17/587,718

(22) Filed: Jan. 28, 2022

Related U.S. Application Data
(60) Provisional application No. 63/143,114, filed on Jan. 29, 2021.

(51) Int. Cl. B08B 15/04; B03C 1/02

(52) U.S. Cl. CPC B08B 15/04; B03C 1/02

(57) ABSTRACT

A debris catching device may be provided. The debris catching device may have a body with a central region and a peripheral rim. The debris catching device may further have a tool aperture for accommodating at least one tool. The tool aperture may further have a wheel selection element for changing an aperture shape or size. Lastly, the debris catching device may have a magnet for attracting metal debris and for securing to a tool or work surface.

### BACKGROUND

Electricians, carpenters, plumbers, tradesmen and workers in general must cut into surfaces, including ceilings and walls, creating and spreading debris and dust in the process. Someone, typically the worker, must then clean up the debris left by the work, creating an additional burden. It therefore may be desired to have a device for catching at least a portion of the debris to minimize and/or eliminate any clean-up.

### SUMMARY

A debris catching device may be provided. The debris catching device may have a body with a central region and a peripheral rim. The debris catching device may further have a tool aperture for accommodating at least one tool. The tool aperture may further have a selection element for changing an aperture shape or size. Lastly, the debris catching device may have a sidewall connecting the body and peripheral rim.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

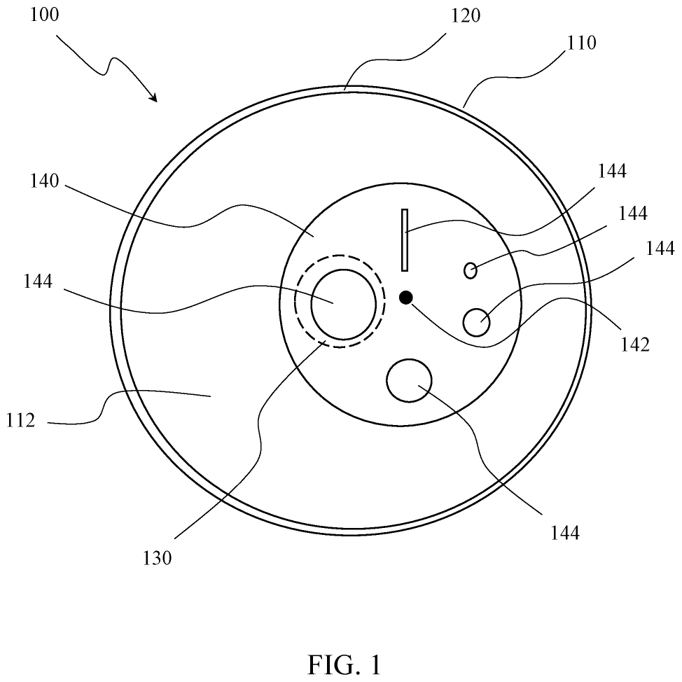

Exemplary FIG. 1 shows an embodiment of a debris catching device;

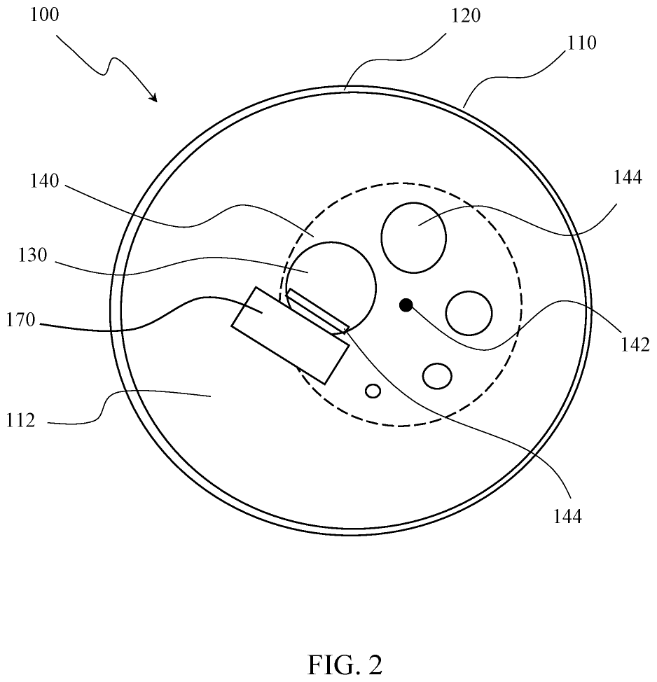

Exemplary FIG. 2 shows an embodiment of a debris catching device;

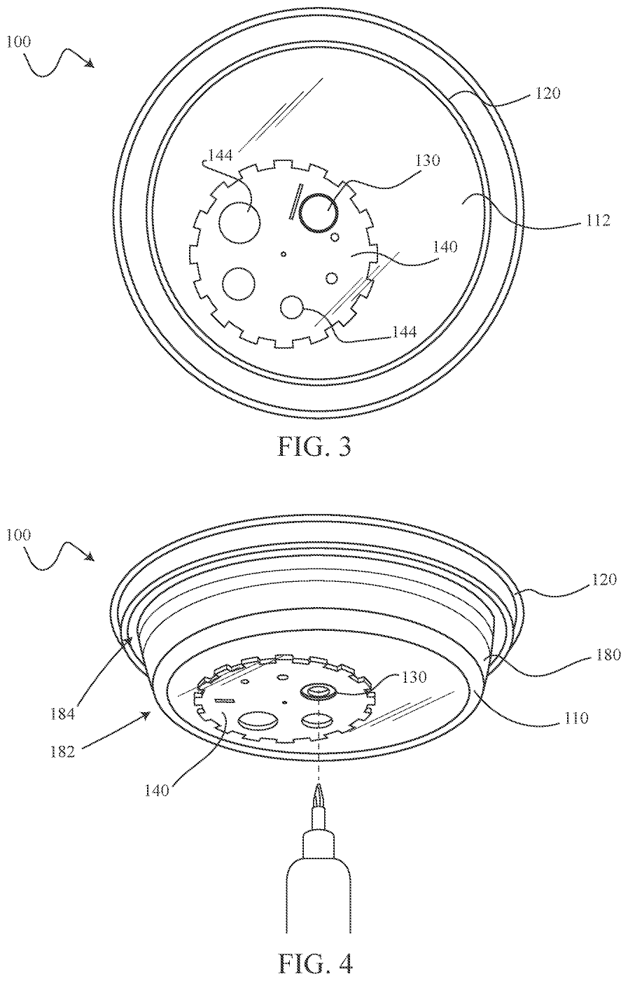

Exemplary FIG. 3 shows an embodiment of a debris catching device;

Exemplary FIG. 4 shows an embodiment of a debris catching device;

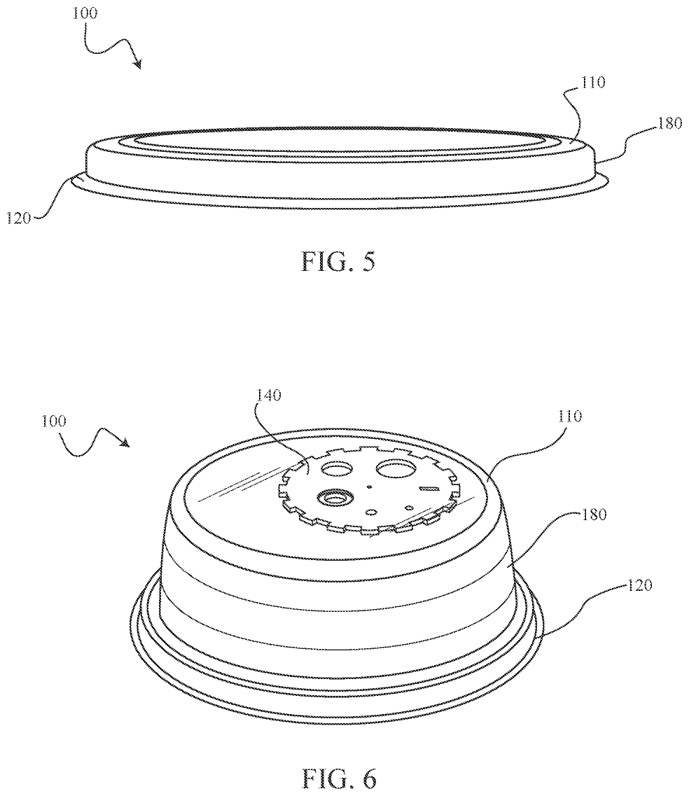

Exemplary FIG. 5 shows an embodiment of a debris catching device; and

Exemplary FIG. 6 shows an embodiment of a debris catching device.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to at least one exemplary embodiment, a debris collection device 100 may be provided. Debris collection device 100 may accommodate the pass-through of a tool or optionally secure to the tool and may be shaped and oriented to collect debris from a work surface during operation of the tool. Device 100 may secure to a tool by friction fit, strap, fastener, magnet, chuck, clamp, hook and loop fastener, adhesive or otherwise as would be understood by a person having ordinary skill in the art. According to exemplary embodiments, the tool may be a drill, knife, saw, screwdriver, multitool, grinder, sander, chisel, punch or any other desired tool, as would be understood by a person having ordinary skill in the art.

Now referring to exemplary FIGS. 1-6, a debris collection device 100 may have a body 110, which may be in the shape of a disc, and may have a peripheral rim or flange 120, which may form an elevated rim or edge around a perimeter of a central region 112 of the body 110. In some embodiments, peripheral rim 120 may be integrally formed with body 110 or may optionally be a separate piece secured to body 110. The device 100 may therefore have a shape resembling a plate, frisbee, cup, or bucket. According to some exemplary embodiments, device 100 may have a plan view shape being a circle, a rectangle, an oval, a triangle, a parallelogram, a trapezoid, a pentagon, a hexagon, an octagon, or any other shape as would be understood by a person having ordinary skill in the art. Device 100 may be any size as would be understood by a person of ordinary skill in the art. By way of a non-limiting example, device 100 may have a diameter or length of between five inches and 20 inches, including an example of 10 inches.

Device 100, including some or all of its and/or regions, may optionally be transparent, clear, translucent, or opaque. At least some embodiments may be transparent, clear or translucent so as to allow a user to see through device 110. Device 100 may be any desired color whether transparent, clear, translucent, or opaque. Device 100 may be made of plastics, glass, silicon, acrylics, rubber, or other polymers, ceramics, metals, or other materials as would be understood by a person having ordinary skill in the art. According to some embodiments, central region 112 and peripheral rim 120 may be made of the same material or may be made of different materials. For example, peripheral rim 120 may be made of a different material having sealing and/or non-marking or non-damaging qualities for engaging a work surface, as shown in exemplary FIG. 3-6. Rim 102 may, for example, be foam, rubber, plastic, or other desired material as would be understood by a person having ordinary skill in the art. According to some further exemplary embodiments, additional material may be attached to peripheral rim to create a better seal and/or to provide non-marking or non-damaging properties for contacting surfaces. Furthermore, various combinations of materials and transparency may be understood by a person of ordinary skill in the art, such that, for example, central region 112 may be transparent and peripheral rim 120 may be opaque, central region 112 may be opaque and peripheral rim 120 may be transparent, both central region 112 and peripheral rim 120 may be opaque, or both central region 112 and peripheral rim 120 may be transparent.

Device 100 may have an aperture or slot 130 disposed in the central region 112, which may be capable of receiving a tool and/or bit. Aperture 130 may optionally be substantially rectangular slot shaped to accommodate a saw and/or may be circular to accommodate a drill bit or hole saw. According to some exemplary embodiments, aperture 130 may be a hole or a slot. According to some alternative exemplary embodiments, aperture 130 may include a hole with a slot extending through the hole and protruding on one or two opposing sides of the hole, as would be understood by a person having ordinary skill in the art. By way of example, without limitation to size, a ¼ inch hole may be provided for drilling and a 1.5″ slot for accommodating a saw or knife may pass through the hole. According to other examples, a hole may be approximately 1/32 inch to approximately 5 inches and a slot may be approximately 1/16 inch long to approximately 5 inches. Still further, according to other exemplary embodiments, an aperture 130 may be provided, which may accommodate both a drill bit or saw and a slide element may overlap and cover aperture 130. The slide element may have a slot cut in a first end and a hole cut in a second end. Therefore, as would be understood by a person having ordinary skill in the art, when the slide is slid such that a first end covers or aligns with aperture 130, a slot aperture may be provided for accommodating a tool through device 100 and when a second end covers or aligns with aperture 130, a hole aperture may be provided for accommodating a tool through device 100. In a slide embodiment, the slide element may have multiple aperture openings, including various size slots or holes. Tool accommodating apertures in the slide element may be spaced such that only one aperture aligns with aperture 130 at a time. The slide element may be slidably affixed to body 110 by a track disposed on a top surface or bottom surface of body 110 or may be slidably affixed within a recess disposed in a top or bottom surface or between the surfaces of body 110.

Still further, according to other exemplary embodiments, a rotating disc or wheel element 140 may be provided as an aperture selector alternative to the slide element. The aperture 130 may be centered in the central region and the wheel element may be off-centered, such that its axis is adjacent the aperture 130 and its radius spans over aperture 130. Therefore, a portion of the wheel element may cover or overlap aperture 130. The wheel element may have at least one tool accommodating aperture or hole such that the tool accommodating aperture or hole 144 may align with the aperture 130, allowing the tool to pass through device 100. The wheel element may allow multiple aperture options, which may be spaced such that only one aperture option aligns with aperture 130 at a time. The options may include different sized apertures which may be a hole or a slot of various sizes, or which may combine a hole and slot, as detailed above as would be understood by a person having ordinary skill in the art. The wheel element may be rotatably affixed to device 100 by an axle 142 and may rotate freely from body 110. The wheel element may be disposed on a top surface of body 110, on a bottom surface of body 110, in a recess of the top or bottom surface of body 110, in a recess between the surfaces of body 110, or any other configuration as would be understood by a person having ordinary skill in the art. Furthermore, the wheel element may optionally be of different transparency from a central region of the device body 112. For example, wheel 130 may be opaque and the central region of the device body 112 may be transparent. Alternatively, both elements may be transparent, opaque, or any combination of transparent and opaque as would be understood by a person having ordinary skill in the art. Rotatable wheel or disc shaped aperture selector 140 may have a grip or teeth around its perimeter to facilitate rotating the selector to a desired aperture selection. Furthermore, aperture selector 140 may temporarily lock in orientations for each respective aperture selection to align with the aperture 130.

According to some exemplary embodiments, aperture 130 and/or the slot or hole disposed through a slide element may be sized to fit snugly around a tool or tool bit, such that debris may not easily pass through aperture 130 around a tool. Alternatively, aperture 130 and/or the slot or hole disposed through the slide element may be sized to loosely accommodate a tool and may allow for oscillation of the tool. Furthermore, in some exemplary embodiments, device 100 may be secured to at least one of a handle, body, chuck, bit, blade, or other portion or attachment of a tool. According to some alternative embodiments, device 100 may be capable of securing or adhering to a work surface. According to still further exemplary embodiments, a sealing material may be disposed in or around aperture 130 to create a complete or partial seal to the tool. For example, a flexible gasket or brush seal may be implemented in aperture 130.

Device 100 may also have a magnet 170 disposed on or in body 110 or peripheral rim 120. Magnet 170 may catch metal debris. Magnet 170 may be disposed near or adjacent to the slot or hole. Magnet 170 may be formed in a surface of device 100 or may be disposed above or protrude from a surface of device 100. According to at least some exemplary embodiments, magnet 170 may also be capable of securing device 100 to a metal or magnetic object, which may include a work surface or a portion of a tool, which may optionally be passing through aperture 130, such as a knife blade, or disposed near or below aperture 130. Magnet 170 may be positioned to be adjacent to the aperture 130 and any hole or aperture in a wheel or slide, when aligned with aperture 130. According to some alternative embodiments, one or more magnets 170 may be disposed on device 100 for collecting metal debris and/or securing device 100 to a surface or tool. Furthermore, magnets 170 may be disposed around a perimeter of device 100 in addition to or instead of being disposed proximate the aperture 130.

Now referring to exemplary FIGS. 4-6, device 100 may optionally have a sidewall 180. Sidewall 180 may connect body 110 and rim 120. Similar to the other elements described herein, sidewall 180 may be any desired color and may be transparent, opaque, or any variation thereof, as would be understood by a person having ordinary skill in the art. According to some exemplary embodiments, sidewall 180 may be substantially cylindrical, forming a bucket or cup shape when combined with body 110. According to still further exemplary embodiments, a bottom end 182 of sidewall 180 may be sized and shaped to match and adjoin approximate a perimeter of body 110, as would be understood in the art. Furthermore, a top end 184 of sidewall 180 may be sized and shaped to match and adjoin a shape of rim 120, as would be understood in the art. In some embodiments, top end 184 and bottom end 182 may have an identical size and shape, while in other embodiments top end 184 and bottom end 182 may have different sizes and shapes. For example, in some embodiments, top end 184 may be a circle with a larger circumference than bottom end 182, which may cause device 100 to have a sidewall 180 forming a substantially conical shape. Sidewall 180 may also be telescopic and may have varying stages of extension. FIG. 5 may show a collapsed sidewall 180, FIG. 4 may show an intermediately extended sidewall 180, and FIG. 6 may show a fully extended sidewall 180. Sidewall 180 may have any number of desired stages of extension.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A debris catching device comprising:
a body with at least one aperture;
a rim;
a sidewall connecting a perimeter of the body with a perimeter of the rim; and
an aperture selector,
wherein the aperture selector aligns with the at least one aperture and has at least two different aperture openings.

2. The debris catching device of claim 1, wherein the sidewall is extendable.

3. The debris catching device of claim 1, further comprising at least one round aperture opening and at least one slot aperture opening.

4. The debris catching device of claim 1, wherein the body is transparent.

5. The debris catching device of claim 1, wherein the rim comprises a non-marking material.

6. The debris catching device of claim 1, wherein the aperture selector is a rotatable disc and wherein the aperture selector is configured to rotate such that separate aperture selections align independently with the aperture.

7. The debris catching device of claim 6, wherein the aperture is centered on the body and wherein the aperture selector is rotatable about an axis offset from the aperture, such that aperture selections disposed around the aperture selector are aligned with the aperture.

8. The debris catching device of claim 6, wherein the aperture selector has a grip element disposed around its perimeter.

9. The debris catching device of claim 1, further comprising at least one magnet.

10. The debris catching device of claim 1, further comprising a non-marking, non-damaging material disposed on the rim.
